(19) United States
(12) Patent Application Publication
(10) Pub. No.: US 2025/0190763 A1
(43) Pub. Date: Jun. 12, 2025

(54) Automated System for Detecting Likelihood of Falsified Outputs from Large Language Models (LLM)

(71) Applicant: Bank of America Corporation, Charlotte, NC (US)

(72) Inventors: Anthony Banuelos, Chicago, IL (US); Stephanie Pirman, Chicago, IL (US); Marvin Osorio, Chicago, IL (US)

(21) Appl. No.: 18/535,069

(22) Filed: Dec. 11, 2023

(51) Int. Cl. G06N 3/0455

(52) U.S. Cl. CPC G06N 3/0455

(57) ABSTRACT

A computing platform may generate, using a test case generation model, a plurality of large language model (LLM) test cases. The computing platform may input, into an LLM, the plurality of LLM test cases, which may produce a plurality of unverified LLM test results. The computing platform may input, into a validation model, the plurality of LLM test cases, which may produce a plurality of validated LLM test results. The computing platform may compare, using a falsified output evaluation model, the plurality of unverified LLM test results with the corresponding plurality of validated LLM test results, which may produce an LLM compliance score for the LLM. The computing platform may compare the LLM compliance score to a compliance threshold. Based on identifying that the LLM compliance score meets or exceeds the compliance threshold, the computing platform may automatically deploy the LLM for use in an enterprise environment.

### BACKGROUND

In some instances, large language models (LLMs) may be vulnerable to intentionally incorrect information being fed into the model's training data via user input (e.g., via a poisoning attack, or the like). For example, poisoning attacks have the potential to coerce the LLM to generate content littered with factual inaccuracies, subjective misinterpretations, fictional information, or the like. These inaccuracies may be referred to as falsified outputs. Deployment of such an LLM may result in substantial threats or risks, depending on the environment in which the LLM is deployed.

### SUMMARY

Aspects of the disclosure provide effective, efficient, scalable, and convenient technical solutions that address and overcome the technical problems associated with evaluating large language models for accuracy. In accordance with one or more embodiments of the disclosure, a computing platform comprising at least one processor, a communication interface, and memory storing computer-readable instructions may generate, using a test case generation model, a plurality of large language model (LLM) test cases. The computing platform may input, into an LLM, the plurality of LLM test cases, which may produce a plurality of unverified LLM test results. The computing platform may input, into a validation model, the plurality of LLM test cases, which may produce a plurality of validated LLM test results. The computing platform may compare, using a falsified output evaluation model, the plurality of unverified LLM test results with the corresponding plurality of validated LLM test results, which may produce an LLM compliance score for the LLM. The computing platform may compare the LLM compliance score to a compliance threshold. Based on identifying that the LLM compliance score meets or exceeds the compliance threshold, the computing platform may automatically deploy the LLM for use in an enterprise environment.

In one or more instances, a first subset of the plurality of LLM test cases may include toxic data test cases and a second subset of the plurality of LLM test cases may include unknown data test cases. In one or more instances, the toxic data test cases may be test cases prompting the LLM to output a false output. In one or more instances, the unknown data test cases may be test cases prompting the LLM to provide an output for an unknown topic.

In one or more examples, the plurality of LLM test cases may be prompts for input to the LLM. In one or more examples, the LLM may be hosted in a sandbox environment.

In one or more instances, based on identifying that the LLM compliance score does not meet or exceed the compliance threshold, the computing platform may identify a significance of the failure to meet or exceed the compliance threshold, where the significance is one of material, significant, or inconsequential. In one or more instances, the computing platform may send, to an enterprise computing device of the enterprise environment, a notification of the significance and one or more commands directing the enterprise computing device to display the notification, which may cause the enterprise computing device to display the notification.

In one or more examples, the compliance threshold may be specific to an industry associated with the enterprise environment. In one or more examples, the computing platform may: 1) train, using historical LLM compliance scores and deviation significance information, the falsified output evaluation model, which may configure the falsified output evaluation model to output the LLM compliance score, and 2) update, via a dynamic feedback loop and using the LLM compliance score and a result of the comparison of the LLM compliance score to the compliance threshold, the falsified output evaluation model.

### BRIEF DESCRIPTION OF DRAWINGS

The present disclosure is illustrated by way of example and is not limited in the accompanying figures in which like reference numerals indicate similar elements and in which:

FIGS. 1A and 1B depict an illustrative computing environment for detecting a likelihood of falsified outputs for LLMs in accordance with one or more example embodiments.

FIGS. 2A-2E depict an illustrative event sequence for detecting a likelihood of falsified outputs for LLMs in accordance with one or more example embodiments.

FIGS. 3-4 depict illustrative user interfaces for detecting a likelihood of falsified outputs for LLMs in accordance with one or more example embodiments.

FIG. 5 depicts an illustrative method for detecting a likelihood of falsified outputs for LLMs in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

The following description relates to determining vulnerability of large language models (LLMs) to providing falsified outputs. For example, via a poisoning attack, an LLM may be vulnerable to intentionally incorrect information being fed into the model's training data via user input. Poisoning attacks may have the potential to coerce the LLM to generate content littered with factual inaccuracies, subjective misinterpretations, or fictional information. These inaccuracies are generally referred to as falsified outputs. There is not currently a method for clearly identifying the vulnerability of such an attack on an LLM, and thus the risk of an attack may pose substantial danger if the model is being leveraged in an environment in an unsupervised or undersupervised fashion.

Accordingly, described herein is a model for identifying such vulnerability. The model may include three major components. The first component includes a supervised dynamic machine learning model for test case generation that dynamically generates test cases. These test cases may fall into two major categories. The first is “toxic data,” which is data that is blatantly false. An example of such a piece of data could be “the moon landing was faked.” This data may be introduced into the model via user input (e.g., querying/asking a question of the LLM). If the LLM is being trained on user input data, this incorrect information may be introduced to the LLM and become a part of the answer for queries made to the LLM. This data may be kept in a data store. The other category of test cases may be unknown topics. Unknown topics may be queries for specific information that the model is unlikely to have been exposed to via the original training set and identifying whether the output from the LLM is valid or is fabricated by the model. An example of this may be asking for a short biography of a relatively unknown person. This dataset may be stored in the same or a different data store.

Both of these data sets may be pushed to a supervised validation machine learning model in which appropriate correct answers may be provided. The second major component may be querying the LLM in a sandbox environment in which the queries may be run in a controlled environment to isolate external factors in testing. This process may be synthesized in a final major component.

The final major component may be a falsified output generation model, that may rate similarity between anticipated answers and observed LLM answers. This component may be informed by the LLM itself and the supervised validation machine learning model. This may be transformed with a risk factor to help enterprises identify the models most susceptible to falsified outputs and poisoning attacks. This rating may take into account industry verticals and other factors in the weighing of risk. The ratings may be on one of the following four decisions: material, significant, inconsequential, and compliant.

In some instances, the supervised models may be supervised by a person. In some instances, this model may attempt to evaluate how significant the threat of an AI attack is, such as poisoning, and how impactful the threat may be.

These techniques may provide a holistic analysis on the severity of falsified LLM outputs through different methods of test cases generated through the supervised machine learning generator. Two different means of machine learning may be performed with the intent of providing a risk analysis level for the AI model's vulnerability to generating falsified outputs. The output of the configuration may be an evaluation of this vulnerability.

Furthermore, the model described herein may focus on potential threats to an LLM and its decision-making capability. The risk analysis component in this model is may be a point in time assessment of the specific threat of falsified outputs and poisoning on an LLM with business specific impacts. The threats this model looks at may be nuanced and may include digital threats with business implications. Additionally, the model benchmarks the risk of a given LLM against other models to provide business recommendations for the least risky models.

These and other features are described in greater detail below.

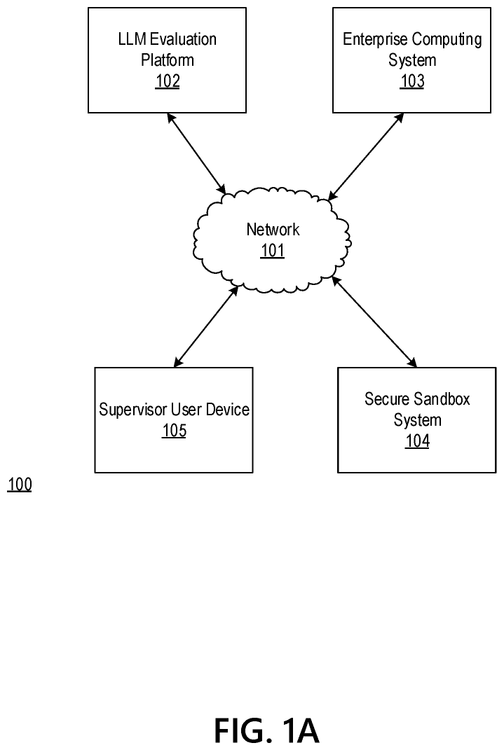

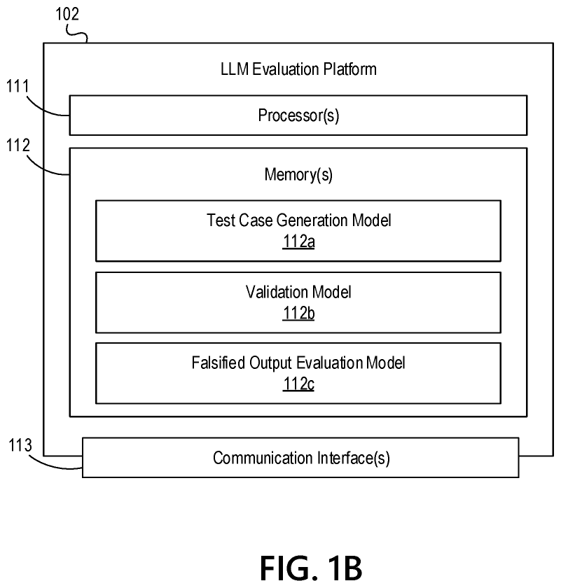

FIGS. 1A-1B depict an illustrative computing environment for detecting a likelihood of falsified outputs from large language models (LLMs) in accordance with one or more example embodiments. Referring to FIG. 1A, computing environment 100 may include one or more computer systems. For example, computing environment 100 may include LLM evaluation platform 102, enterprise computing system 103, secure sandbox system 104, and supervisor user device 105.

LLM evaluation platform 102 may include one or more computing devices (servers, server blades, or the like) and/or other computer components (e.g., processors, memories, communication interfaces, or the like). For example, the LLM evaluation platform 102 may be configured to train, host, and apply a test case generation model configured to generate test cases for an LLM, and feed the test cases to the LLM accordingly. In some instances, the LLM evaluation platform 102 may train, host, and apply a validation model to generate validated outputs corresponding to the test cases. In some instances, the LLM evaluation platform 102 may train, host, and apply a falsified output evaluation model to compare the LLM outputs to the validated outputs, and to generate compliance scores for the LLM accordingly.

Enterprise computing system 103 may be or include one or more devices (e.g., laptop computers, desktop computer, smartphones, tablets, servers, server blades, and/or other devices) configured for use in displaying the results of the LLM compliance testing performed by the LLM evaluation platform 102. For example, the enterprise computing system 103 may be configured to display compliance and/or non-compliance notifications of the LLM. In some instances, the enterprise computing system 103 may be further configured to deploy LLMs for use based on the results of the compliance testing. Any number of such user devices may be used to implement the techniques described herein without departing from the scope of the disclosure.

Secure sandbox system 104 may include one or more computing devices (servers, server blades, or the like) and/or other computer components (e.g., processors, memories, communication interfaces, or the like). In some instances, the secure sandbox system 104 may be and/or otherwise provide an isolated environment for execution of the LLM during compliance testing. In some instances, the secure sandbox system 104 may be a unique system, separate from the LLM evaluation platform 102. In other instances, the secure sandbox system 104 may be hosted within the LLM evaluation platform 102, but may nevertheless comprise an isolation environment separate from the models and/or processing described above with regard to the LLM evaluation platform 102.

Supervisor user device 105 may be or include one or more devices (e.g., laptop computers, desktop computer, smartphones, tablets, and/or other devices) configured for use in providing model supervision. For example, the supervisor user device 105 may be operated by an employee of the enterprise organization corresponding to the LLM evaluation platform 102. In some instances, the supervisor user device 105 may be configured to display graphical user interfaces (e.g., model supervision interfaces, or the like), which may, e.g., enable the user of the supervisor user device 105 to validate and/or otherwise provide input on model results. Any number of such user devices may be used to implement the techniques described herein without departing from the scope of the disclosure.

Computing environment 100 also may include one or more networks, which may interconnect LLM evaluation platform 102, enterprise computing system 103, secure sandbox system 104, and supervisor user device 105. For example, computing environment 100 may include a network 101 (which may interconnect, e.g., LLM evaluation platform 102, enterprise computing system 103, secure sandbox system 104, and supervisor user device 105).

In one or more arrangements, LLM evaluation platform 102, enterprise computing system 103, secure sandbox system 104, and supervisor user device 105 may be any type of computing device capable of receiving a user interface, receiving input via the user interface, and communicating the received input to one or more other computing devices, and/or training, hosting, executing, and/or otherwise maintaining one or more machine learning models. For example, LLM evaluation platform 102, enterprise computing system 103, secure sandbox system 104, supervisor user device 105, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of LLM evaluation platform 102, enterprise computing system 103, secure sandbox system 104, and supervisor user device 105 may, in some instances, be special-purpose computing devices configured to perform specific functions.

Referring to FIG. 1B, LLM evaluation platform 102 may include one or more processors 111, memory 112, and communication interface 113. A data bus may interconnect processor 111, memory 112, and communication interface 113. Communication interface 113 may be a network interface configured to support communication between LLM evaluation platform 102 and one or more networks (e.g., network 101, or the like). Memory 112 may include one or more program modules having instructions that when executed by processor 111 cause LLM evaluation platform 102 to perform one or more functions described herein and/or one or more databases that may store and/or otherwise maintain information which may be used by such program modules and/or processor 111. In some instances, the one or more program modules and/or databases may be stored by and/or maintained in different memory units of LLM evaluation platform 102 and/or by different computing devices that may form and/or otherwise make up LLM evaluation platform 102. For example, memory 112 may have, host, store, and/or include test case generation model 112a, validation model 112b, and falsified output evaluation model 112c. Test case generation model 112a may have instructions that direct and/or cause LLM evaluation platform 102 to execute advanced techniques to generate test cases for LLMs. Validation model 112b may have instructions that direct and/or cause LLM evaluation platform 102 to execute advanced techniques to generate validated results for the test cases. Falsified output evaluation model 112c may have instructions that direct and/or cause LLM evaluation platform 102 to execute advanced techniques to compare the validated results to outputs of the LLM, and produce LLM compliance results accordingly. In some instances, the LLM evaluation platform 102 may train, deploy, and/or otherwise refine these models through both initial training and one or more dynamic feedback loops, which may, e.g., enable continuous improvement of the models and further optimize the models for evaluating LLM performance and compliance.

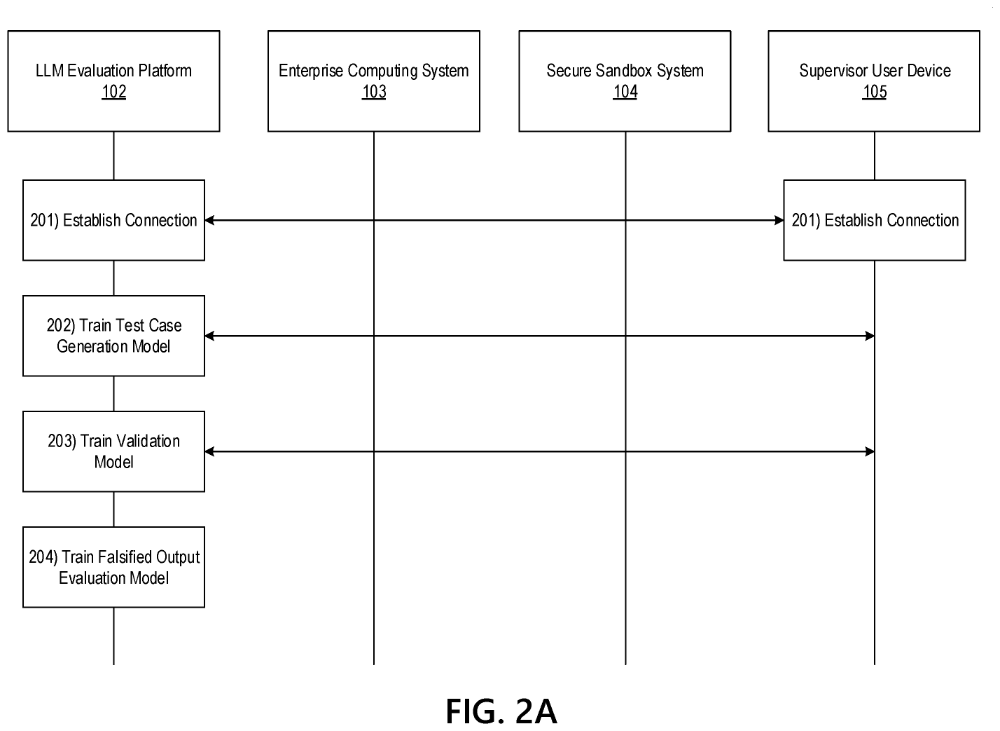

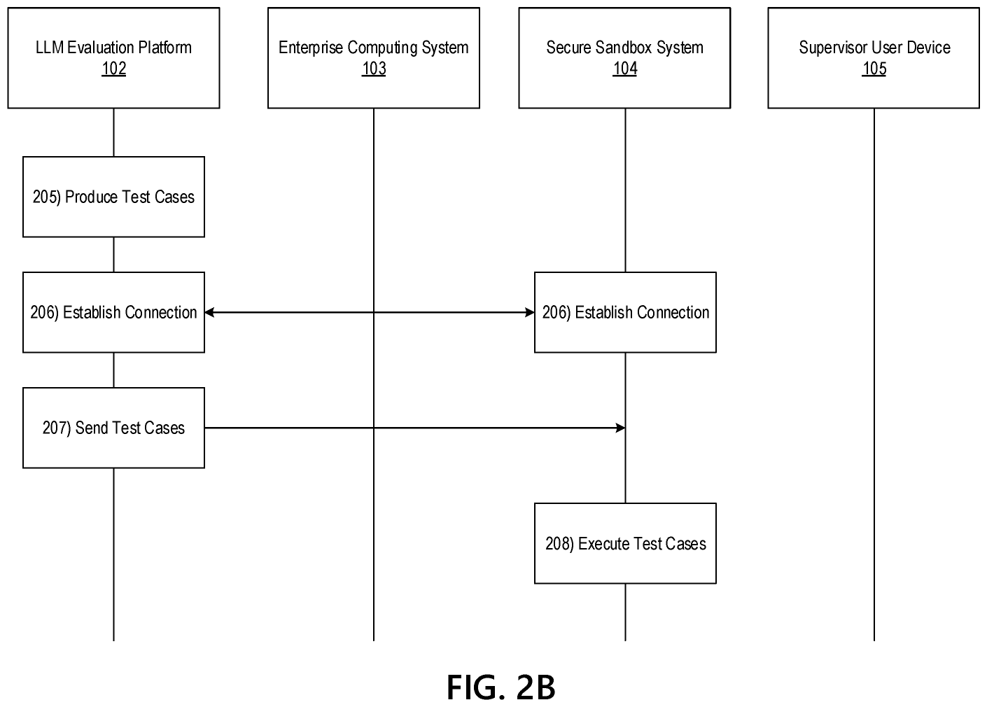

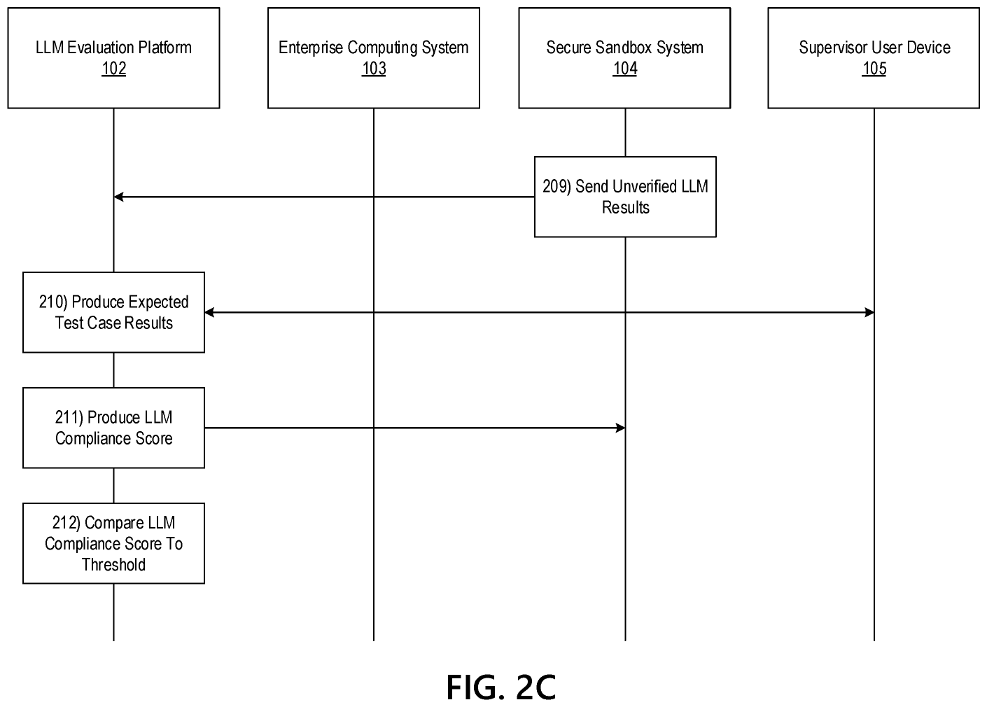

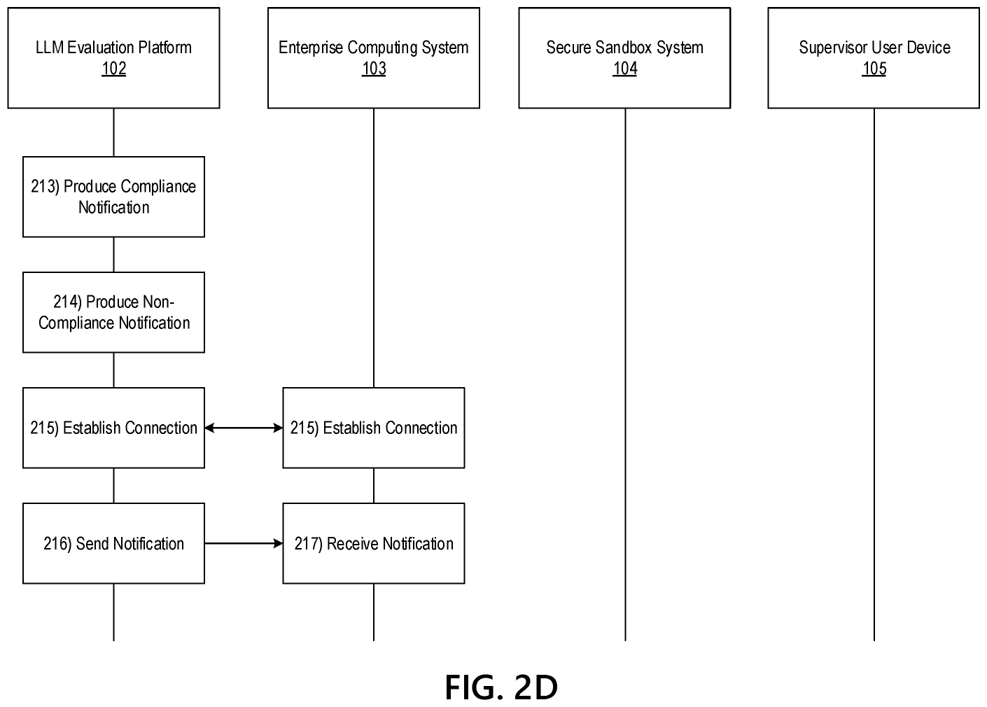

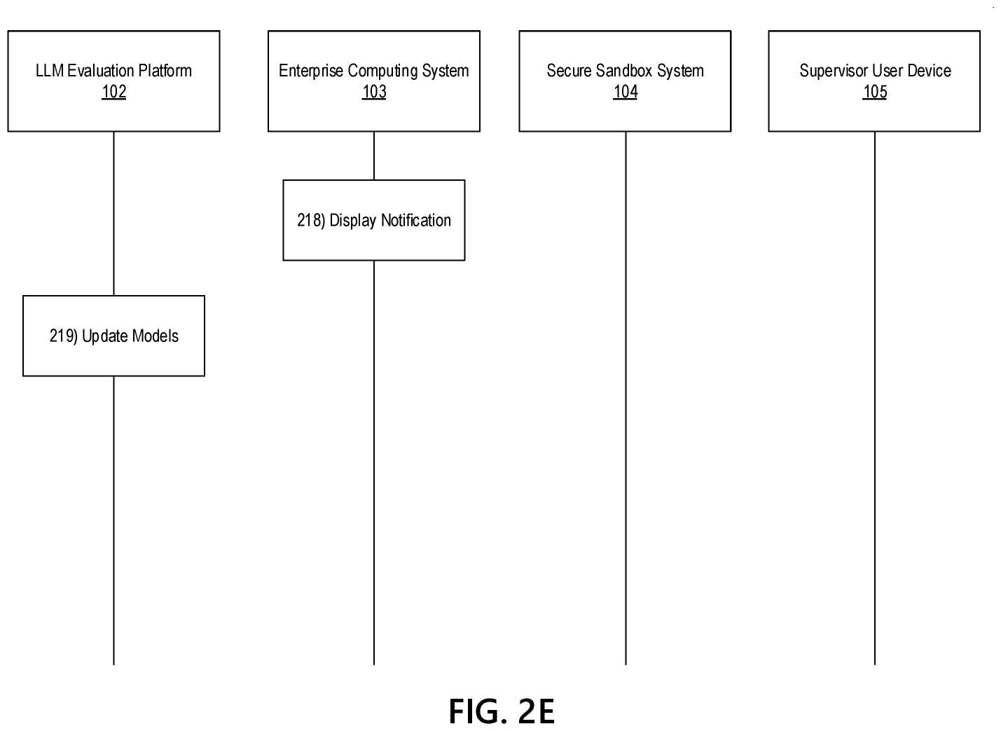

FIGS. 2A-2E depict an illustrative event sequence for detecting a likelihood of falsified outputs from large language models (LLMs) in accordance with one or more example embodiments. Referring to FIG. 2A, at step 201, the supervisor user device 105 may establish a connection with the LLM evaluation platform 102. For example, the supervisor user device 105 may establish a first wireless data connection with the LLM evaluation platform 102 to link the supervisor user device 105 to the LLM evaluation platform 102 (e.g., in preparation for training and supervising one or more models). In some instances, the supervisor user device 105 may identify whether a connection is already established with the LLM evaluation platform 102. If a connection is already established with the LLM evaluation platform 102, the supervisor user device 105 might not re-establish the connection. If a connection is not yet established with the LLM evaluation platform 102, the supervisor user device 105 may establish the first wireless data connection as described herein.

At step 202, the LLM evaluation platform 102 may train the test case generation model. For example, the LLM evaluation platform 102 may train the test case generation model to produce LLM test cases, which may, e.g., be LLM prompts. In some instances, the LLM evaluation platform 102 may train the test case generation model to produce toxic data test cases, comprising test cases including blatantly false information. Additionally or alternatively, the LLM evaluation platform 102 may train the test case generation model to produce unknown topic test cases, which may be test cases corresponding to queries for specific information that the model is unlikely to have been exposed to via an original training set. In some instances, additional types of test cases may be generated without departing from the scope of the disclosure.

In some instances, to perform such training, the LLM evaluation platform 102 may receive historical prompt information, known toxic data, information indicating that a topic comprises “unknown data,” and/or other information. In some instances, prompts may be labelled with corresponding test case information (e.g., toxic, unknown, or the like), which may, e.g., train the test case generation model to generate test cases of these particular types. In some instances, this labelling may be automatically performed by the LLM evaluation platform 102 using one or more clustering and/or other techniques. Additionally or alternatively, these test cases may be labeled based on interaction between the supervisor user device 105 and the LLM evaluation platform 102 (e.g., a supervisor providing labeling information via an interface of the supervisor user device 105). In doing so, the test case generation model may be trained to establish correlations between test cases (e.g., LLM prompts) and a corresponding type of test case (e.g., toxic data, unknown data, or the like), which may, e.g., cause the test case generation model to output test cases of these particular types.

In some instances, in training the test case generation model, LLM evaluation platform 102 may use one or more supervised learning techniques (e.g., decision trees, bagging, boosting, random forest, k-NN, linear regression, artificial neural networks, support vector machines, and/or other supervised learning techniques), unsupervised learning techniques (e.g., classification, regression, clustering, anomaly detection, artificial neutral networks, and/or other unsupervised models/techniques), and/or other techniques.

At step 203, the LLM evaluation platform 102 may train the validation model. For example, the LLM evaluation platform 102 may train the validation model to produce validated results to the test cases generated by the test case generation model. In some instances, the LLM evaluation platform 102 may train the validation model to produce validated results to toxic data test cases, unknown topic test cases, and/or other test cases. For example, the LLM evaluation platform 102 may train the validation model to recognize that a particular test case corresponds to toxic data, unknown data, or the like, and to provide an output accordingly. Furthermore, the LLM evaluation platform 102 may train the validation model to output information expected in an output of an LLM in response to input of one of the test cases.

In some instances, to perform such training, the LLM evaluation platform 102 may receive the test cases produced by the test case generation model, the labelling information of the test cases, validated response information, and/or other information. In some instances, these validated results may be automatically produced by the validation model. Additionally or alternatively, these validated results may be produced based on interaction between the supervisor user device 105 and the LLM evaluation platform 102 (e.g., a supervisor providing validation of the results via an interface of the supervisor user device 105). In doing so, the validation model may be trained to establish correlations between expected results for the test cases and the test cases themselves, which may, e.g., cause the test case generation model to output the expected results based on input of a particular test case.

In some instances, in training the validation model, LLM evaluation platform 102 may use one or more supervised learning techniques (e.g., decision trees, bagging, boosting, random forest, k-NN, linear regression, artificial neural networks, support vector machines, and/or other supervised learning techniques), unsupervised learning techniques (e.g., classification, regression, clustering, anomaly detection, artificial neutral networks, and/or other unsupervised models/techniques), and/or other techniques.

At step 204, the LLM evaluation platform 102 may train the falsified output evaluation model. For example, the LLM evaluation platform 102 may train the falsified output evaluation model to produce LLM compliance scores and/or other results indicating compliance/performance of the given LLM. For example, the LLM evaluation platform 102 may train the falsified output evaluation model to compare the expected results from the validation model with the output of a particular LLM, and to quantify any discrepancies detected therein.

In some instances, to perform such training, the LLM evaluation platform 102 may receive historical expected results, historical LLM outputs, the test cases, industry information (e.g., different discrepancies may have different impacts on different industries), historical compliance scores, and/or other information. In some instances, the different discrepancies may be labelled with corresponding compliance scores for different industries, which may, e.g., train the falsified output evaluation model to output compliance scores for various detected LLM outputs for various industries.

In some instances, the LLM evaluation platform 102 may further train the falsified output evaluation model to establish compliance thresholds for different industries, where compliance scores that meet or exceed the compliance threshold may have their corresponding LLMs tagged as compliant, whereas compliance scores that do not meet or exceed the compliance threshold may have their corresponding LLMs tagged as non-compliant. In some instances, the LLM evaluation platform 102 may further establish sub-thresholds within the non-compliance category, where the thresholds define compliance score ranges for material non-compliance, significant non-compliance, inconsequential non-compliance, and/or other labels, which may e.g., indicate decreasing levels of significance of a detected discrepancy between the LLM output and the expected results. For example, inconsequential may indicate that although minor facts in the LLM output are changed or incorrect, it would not significantly alter how someone would act on the information of the output. Significant non-compliance may indicate multiple inconsequential discrepancies. Material non-compliance may indicate that errors in the output would affect major decisions for an individual or enterprise relying on the LLM output. In some instances, these thresholds and/or sub-thresholds may be industry specific. For example, a retail enterprise may have a larger risk appetite than a financial institution, or the like, and thus a discrepancy that may be materially non-compliant for the financial institution may be inconsequential for the retail enterprise. In some instances, the LLM evaluation platform 102 may further train the falsified output evaluation model to output automated actions to be performed based on the compliance scores and/or the corresponding compliance score range (e.g., automatically deploy the LLM, perform LLM selection, provide LLM recommendations, provide compliance/non-compliance indications, or the like).

In some instances, in training the falsified output evaluation model, LLM evaluation platform 102 may use one or more supervised learning techniques (e.g., decision trees, bagging, boosting, random forest, k-NN, linear regression, artificial neural networks, support vector machines, and/or other supervised learning techniques), unsupervised learning techniques (e.g., classification, regression, clustering, anomaly detection, artificial neutral networks, and/or other unsupervised models/techniques), and/or other techniques.

Referring to FIG. 2B, at step 205, the LLM evaluation platform 102 may produce test cases. For example, the LLM evaluation platform 102 may input toxic information, unknown information, and/or other information into the test case generation model, which may, e.g., cause the test case generation model to produce an LLM prompt (e.g., a test case) corresponding to the input information. For example, a given toxic data test case may be a query or question prompting the LLM about whether or not the moon landing was faked, and/or otherwise prompting the LLM with questions based on blatantly false information. In producing the unknown test case, the test case generation model may produce a query or question prompting the LLM for specific information that the LLM is unlikely to have been exposed to, such as prompting for a biography of a relatively unknown person.

At step 206, the LLM evaluation platform 102 may establish a connection with the secure sandbox system 104. In some instances, the LLM evaluation platform 102 may establish a second wireless data connection with the secure sandbox system 104 to link the LLM evaluation platform 102 to the secure sandbox system 104 (e.g., in preparation for sending test cases for processing). In some instances, the LLM evaluation platform 102 may identify whether or not a connection is already established with the secure sandbox system 104. If a connection is already established with the secure sandbox system 104, the LLM evaluation platform 102 might not re-establish the connection. If the LLM evaluation platform 102 is not yet established with the secure sandbox system 104, the LLM evaluation platform 102 may establish the second wireless data connection as described herein.

At step 207, the LLM evaluation platform 102 may send one or more of the test cases, produced at step 205, to the secure sandbox system 104. For example, the secure sandbox system 104 may host one or more LLMs for testing, and may receive the test cases accordingly. In some instances, the LLM evaluation platform 102 may send the test cases via the communication interface 113 and while the second wireless data connection is established.

At step 208, the secure sandbox system 104 may input the test cases into the one or more LLMs being tested, to produce LLM outputs accordingly. For example, the LLM may output a response to the test case which may be either a correct or falsified output. As a particular example, for the moon landing test case, if the LLM outputs a response indicating that the moon landing was faked, this may be a falsified output, indicating that the LLM failed to recognize toxic data. In contrast, if the LLM outputs a response indicating that the moon landing did in fact occur, and that faking the moon landing is a common conspiracy theory, the LLM successfully recognized the toxic data. Similarly, if the LLM outputs a response including made up or otherwise incorrect information for an unknown individual in response to a prompt to provide a summary of this individual, the LLM fails to recognize that the individual (or other topic) is unknown and may provide a falsified output. In contrast, if the LLM recognizes that it does not have enough information to provide an accurate response, it may be apparent that the LLM recognized that the topic or individual is unknown.

Referring to FIG. 2C, at step 209, the secure sandbox system 104 may send the LLM results to the LLM evaluation platform 102. For example, the secure sandbox system 104 may send the LLM results to the LLM evaluation platform 102 while the second wireless data connection is established.

At step 210, the LLM evaluation platform 102 may produce expected test case results using the validation model. For example, the LLM evaluation platform 102 may input the test cases into the validation model to produce the expected test case results. In some instances, as described above, this may include interaction with the supervisor user device 105, which may e.g., comprise human validation of the expected test case results. In doing so, accuracy of the expected test case results may be ensured. In some instances, in addition or as an alternative to interacting with the supervisor user device 105, the validation model may be configured to automatically obtain third party and/or other stored information that may be used to automatically validate the expected test case results.

At step 211, the LLM evaluation platform 102 may input the LLM outputs and the expected test case results into the falsified output evaluation model 112c to produce a compliance score. For example, the LLM evaluation platform 102 may compare the LLM outputs to the corresponding expected test case results to identify discrepancies between them. Based on the discrepancy, the falsified output evaluation model 112 may produce a compliance score, and may compare the compliance score to one or more thresholds (which may, e.g., be specific to a particular industry) to produce a compliance result. For example, the compliance score may be a value between 0 and 100, with 100 indicating perfect compliance and 0 indicating no compliance. As a particular example, compliance scores between 70 and 100 (inclusive) may be flagged as “compliant,” scores between 60 and 69 (inclusive) may be flagged as “non-compliant: inconsequential,” scores between 40 and 59 (inclusive) may be flagged as “non-compliant: significant,” and scores below 40 may be flagged as “non-compliant: material.” In some instances, the LLM evaluation platform 102 may also identify one or more actions to be automatically performed by the enterprise computing system 103 based on the compliance result (e.g., automatically deploy the LLM, perform LLM selection, provide LLM recommendations, provide compliance/non-compliance indications, or the like).

At step 212, the LLM evaluation platform 102 may compare the compliance score to the compliance threshold (e.g., the threshold of 70 in the example describe above), distinguishing between models that are compliant and non-compliant. Additionally or alternatively, the LLM evaluation platform 102 may use the compliance result (e.g., the label) to identify whether or not the LLM is compliant. In instances where the LLM evaluation platform 102 identifies that the LLM is compliant, it may proceed to step 213. Otherwise, in instances where the LLM evaluation platform 102 identifies that the LLM is non-compliant, it may proceed to step 214.

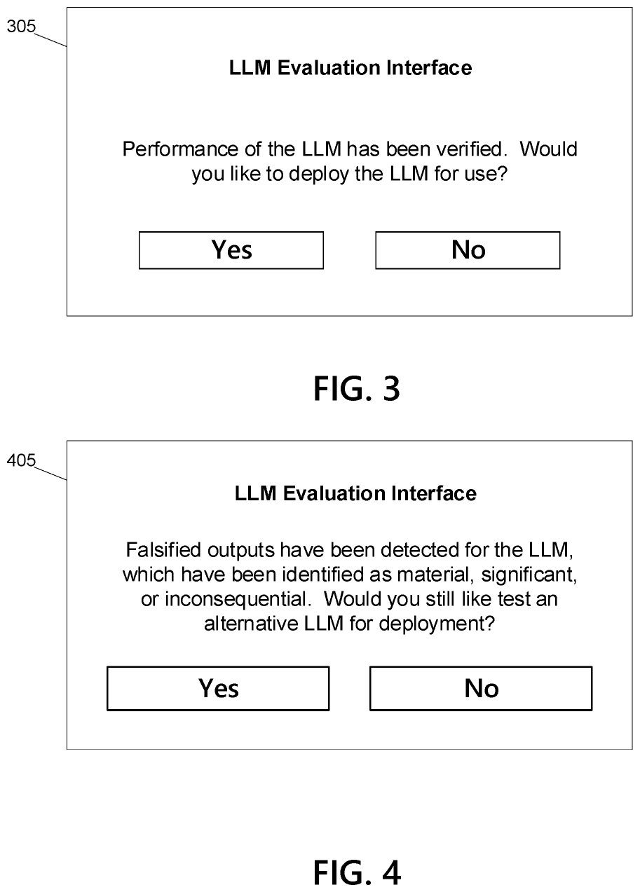

Referring to FIG. 2D, at step 213, the LLM evaluation platform 102 may produce a notification indicating that the LLM is compliant. For example, the LLM evaluation platform 102 may produce a notification similar to notification 305, which is displayed in FIG. 3. In some instances, the notification may include multiple LLMs and indicate a comparison between them. The LLM evaluation platform 102 may then proceed to step 215.

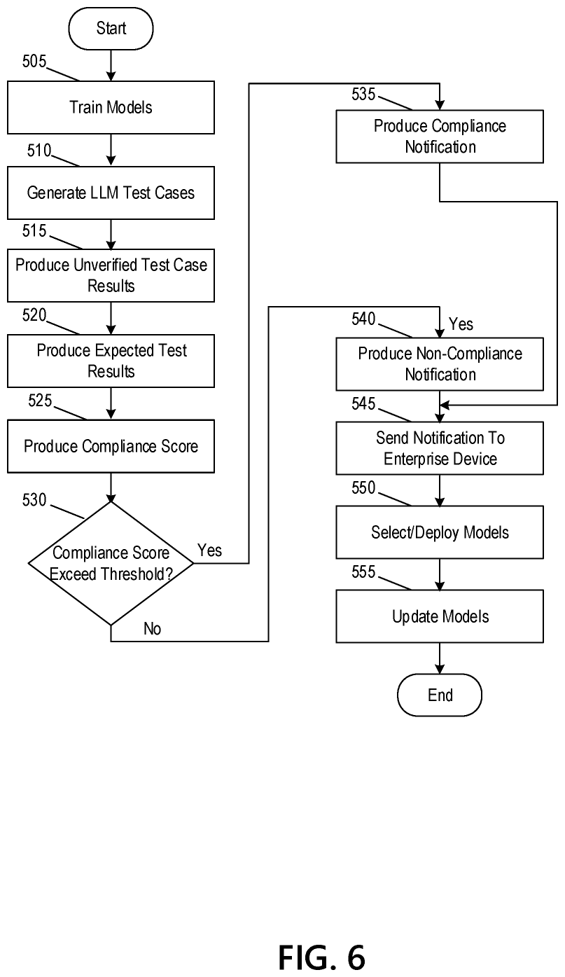

Returning to step 212, if the LLM evaluation platform 102 identifies that the LLM is non-compliant, the LLM evaluation platform 102 may have proceeded to step 214. At step 214, the LLM evaluation platform 102 may produce a notification indicating that the LLM is non-compliant. For example, the LLM evaluation platform 102 may produce a notification similar to notification 405, which is illustrated in FIG. 4. In some instances, the notification may include multiple LLMs and indicate a comparison between them.

At step 215, the LLM evaluation platform 102 may establish a connection with the enterprise computing system 103. For example, the LLM evaluation platform 102 may establish a third wireless data connection with the enterprise computing system 103 to link the LLM evaluation platform 102 to the enterprise computing system 103 (e.g., in preparation for sending the notification generated at step 213/214). In some instances, the LLM evaluation platform 102 may identify whether a connection is already established with the enterprise computing system 103. If a connection is not yet established with the enterprise computing system 103, the LLM evaluation platform 102 may establish the third wireless data connection as described herein. If a connection is established with the enterprise computing system 103, the LLM evaluation platform 102 might not re-establish the connection.

At step 216, the LLM evaluation platform 102 may send the notification to the enterprise computing system 103. For example, the LLM evaluation platform 102 may send the notification to the enterprise computing system 103 via the communication interface 113 and while the third wireless data connection is established. In some instances, the LLM evaluation platform 102 may also send one or more commands directing the enterprise computing system 103 to display the notification, and/or perform one or more automated actions (e.g., automatically deploy the LLM, perform LLM selection, provide LLM recommendations, provide compliance/non-compliance indications, or the like).

At step 217, the enterprise computing system 103 may receive the notification sent at step 216. For example, the enterprise computing system 103 may receive the notification while the third wireless data connection is established. In some instances, the enterprise computing system 103 may also receive the commands directing the enterprise computing system 103 to display the notification and/or perform one or more automated actions (e.g., automatically deploy the LLM, perform LLM selection, provide LLM recommendations, provide compliance/non-compliance indications, or the like).

Referring to FIG. 2E, at step 218, based on or in response to the one or more commands received at step 217, the enterprise computing system 103 may display the notification and/or perform one or more automated actions (e.g., automatically deploy the LLM, perform LLM selection, provide LLM recommendations, provide compliance/non-compliance indications, or the like).

At step 219, the LLM evaluation platform 102 may update the test case generation model, validation model, and/or falsified output evaluation model based on the test cases, expected results, LLM results, comparison results, compliance scores, compliance results, automated actions, and/or other information. In doing so, the LLM evaluation platform 102 may continue to refine test case generation model, validation model, and/or falsified output evaluation model using a dynamic feedback loop, which may, e.g., increase the accuracy and effectiveness of the models in evaluating LLMs for output compliance and accuracy. For example, the LLM evaluation platform 102 may reinforce, modify, and/or otherwise update the test case generation model, validation model, and/or falsified output evaluation model, thus causing the models to continuously improve.

In some instances, the LLM evaluation platform 102 may continuously refine the test case generation model, validation model, and/or falsified output evaluation model. In some instances, the LLM evaluation platform 102 may maintain an accuracy threshold for the test case generation model, validation model, and/or falsified output evaluation model, and may pause refinement (through the dynamic feedback loops) of the models if the corresponding accuracy is identified as greater than the corresponding accuracy threshold. Similarly, if the accuracy fails to be equal or less than the given accuracy threshold, the LLM evaluation platform 102 may resume refinement of the model through the corresponding dynamic feedback loop. Although the testing of a single LLM is describe, any number of LLMs may be evaluated using the methods described above without departing from the scope of the disclosure.

FIG. 5 depicts an illustrative method for detecting a likelihood of falsified outputs from large language models (LLMs) in accordance with one or more example embodiments. Referring to FIG. 5, at step 505, a computing platform comprising one or more processors, memory, and a communication interface may train a test case generation model, validation model, and/or falsified output evaluation model. At step 510, the computing platform may generate LLM test cases using the test case generation model. At step 515, the computing platform may produce test case results using an LLM. At step 520, the computing platform may produce expected test results using the validation model. At step 525, the computing platform may produce a compliance score using the falsified output evaluation model to compare the LLM results with the expected results. At step 530, the computing platform may identify whether the compliance score meets or exceeds a compliance threshold. If the compliance score does meet or exceed the compliance threshold, the computing platform may proceed to step 535 to generate a compliance notification. Otherwise, if the compliance score does not meet or exceed the compliance threshold, the computing platform may proceed to step 540 to generate a non-compliance notification. At step 545, the computing platform may send the notification to an enterprise user device. At step 550, the computing platform may select and/or otherwise deploy LLMs based on their compliance. At step 555, the computing platform may update the test case generation model, validation model, and/or falsified output evaluation model.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
generate, using a test case generation model, a plurality of large language model (LLM) test cases;
input, into an LLM, the plurality of LLM test cases, wherein inputting the plurality of LLM test cases into the LLM produces a plurality of unverified LLM test results;
input, into a validation model, the plurality of LLM test cases, wherein inputting the plurality of LLM test cases into the validation model produces a plurality of validated LLM test results;
compare, using a falsified output evaluation model, the plurality of unverified LLM test results with the corresponding plurality of validated LLM test results, wherein the comparison produces an LLM compliance score for the LLM;
compare the LLM compliance score to a compliance threshold; and
based on identifying that the LLM compliance score meets or exceeds the compliance threshold, automatically deploy the LLM for use in an enterprise environment.

2. The computing platform of claim 1, wherein a first subset of the plurality of LLM test cases comprises toxic data test cases and a second subset of the plurality of LLM test cases comprises unknown data test cases.

3. The computing platform of claim 2, wherein the toxic data test cases comprise test cases prompting the LLM to output a false output.

4. The computing platform of claim 2, wherein the unknown data test cases comprise test cases prompting the LLM to provide an output for an unknown topic.

5. The computing platform of claim 1, wherein the plurality of LLM test cases comprise prompts for input to the LLM.

6. The computing platform of claim 1, wherein the LLM is hosted in a sandbox environment.

7. The computing platform of claim 1, wherein the memory stores additional computer readable instructions that, when executed by the at least one processor, cause the computing platform to:
based on identifying that the LLM compliance score does not meet or exceed the compliance threshold, identify a significance of the failure to meet or exceed the compliance threshold, wherein the significance comprises one of material, significant, or inconsequential.

8. The computing platform of claim 7, wherein the memory stores additional computer readable instructions that, when executed by the at least one processor, cause the computing platform to:
send, to an enterprise computing device of the enterprise environment, a notification of the significance and one or more commands directing the enterprise computing device to display the notification, wherein sending the one or more commands directing the enterprise computing device to display the notification causes the enterprise computing device to display the notification.

9. The computing platform of claim 1, wherein the compliance threshold is specific to an industry associated with the enterprise environment.

10. The computing platform of claim 7, wherein the memory stores additional computer readable instructions that, when executed by the at least one processor, cause the computing platform to:
train, using historical LLM compliance scores and deviation significance information, the falsified output evaluation model, wherein training the falsified output evaluation model configures the falsified output evaluation model to output the LLM compliance score; and
update, via a dynamic feedback loop and using the LLM compliance score and a result of the comparison of the LLM compliance score to the compliance threshold, the falsified output evaluation model.

11. A method comprising:
at a computing platform comprising at least one processor, a communication interface, and memory:
generating, using a test case generation model, a plurality of large language model (LLM) test cases;
inputting, into an LLM, the plurality of LLM test cases, wherein inputting the plurality of LLM test cases into the LLM produces a plurality of unverified LLM test results;
inputting, into a validation model, the plurality of LLM test cases, wherein inputting the plurality of LLM test cases into the validation model produces a plurality of validated LLM test results;
comparing, using a falsified output evaluation model, the plurality of unverified LLM test results with the corresponding plurality of validated LLM test results, wherein the comparison produces an LLM compliance score for the LLM;
comparing the LLM compliance score to a compliance threshold; and
based on identifying that the LLM compliance score meets or exceeds the compliance threshold, automatically deploying the LLM for use in an enterprise environment.

12. The method of claim 11, wherein a first subset of the plurality of LLM test cases comprises toxic data test cases and a second subset of the plurality of LLM test cases comprises unknown data test cases.

13. The method of claim 12, wherein the toxic data test cases comprise test cases prompting the LLM to output a false output.

14. The method of claim 12, wherein the unknown data test cases comprise test cases prompting the LLM to provide an output for an unknown topic.

15. The method of claim 11, wherein the plurality of LLM test cases comprise prompts for input to the LLM.

16. The method of claim 11, wherein the LLM is hosted in a sandbox environment.

17. The method of claim 11, further comprising:
based on identifying that the LLM compliance score does not meet or exceed the compliance threshold, identifying a significance of the failure to meet or exceed the compliance threshold, wherein the significance comprises one of material, significant, or inconsequential.

18. The method of claim 17, further comprising:
sending, to an enterprise computing device of the enterprise environment, a notification of the significance and one or more commands directing the enterprise computing device to display the notification, wherein sending the one or more commands directing the enterprise computing device to display the notification causes the enterprise computing device to display the notification.

19. The method of claim 11, wherein the compliance threshold is specific to an industry associated with the enterprise environment.

20. One or more non-transitory computer-readable media storing instructions that, when executed by a computing platform comprising at least one processor, a communication interface, and memory, cause the computing platform to:
generate, using a test case generation model, a plurality of large language model (LLM) test cases;
input, into an LLM, the plurality of LLM test cases, wherein inputting the plurality of LLM test cases into the LLM produces a plurality of unverified LLM test results;
input, into a validation model, the plurality of LLM test cases, wherein inputting the plurality of LLM test cases into the validation model produces a plurality of validated LLM test results;
compare, using a falsified output evaluation model, the plurality of unverified LLM test results with the corresponding plurality of validated LLM test results, wherein the comparison produces an LLM compliance score for the LLM;
compare the LLM compliance score to a compliance threshold; and
based on identifying that the LLM compliance score meets or exceeds the compliance threshold, automatically deploy the LLM for use in an enterprise environment.
